(19) United States
(12) Patent Application Publication
(10) Pub. No.: US 2008/0222882 A1
(43) Pub. Date: Sep. 18, 2008

(54) DEVICE FOR ASSEMBLING ENGAGING PARTS

(76) Inventor: HSIN-WEN GUNG, Kaohsiung (TW)

Correspondence Address: G. LINK CO., LTD., 3550 BELL ROAD, MINOOKA, IL, 60447, US

(21) Appl. No.: 11/685,777

(22) Filed: Mar. 14, 2007

(51) Int. Cl. B23P 19/00

(52) U.S. Cl. 29/700

(57) ABSTRACT

A device for assembling an engaging part being joined to a work piece includes a base, a driving part, a locating part, a press part and an expanding part. The base is a rectangular frame provides a rectangular hollow space. The driving part is disposed at one of the frame sides of the base. The locating part is disposed in the hollow space and beside the driving part. The press part is disposed in the hollow space and joined to the locating part such that it is capable of moving reciprocally. The work piece pan is disposed in the hollow space next to another frame side of the base and is opposite to the press part. The expanding part is disposed in the work piece pan for performing assembling job of the engaging part and the work piece simply, safely and effectively.

### BACKGROUND OF THE INVENTION

1. Field of the Invention

The present invention is related to a assembling device and particularly to a device for assembling engaging parts to work pieces.

2. Brief Description of the Related Art

Many work pieces need to be assembled with engaging parts. For instance, the inner strip bar of RAM (random access memory) with cooling fins is clamped with two engaging parts in order to allow the cooling fins being attached to the inner strip bar. The engaging parts are fabricated with sheet material being bent as a U shape and two lateral sides of the respective engaging part are closer to each other so as to be capable of clamp the work piece. Conventionally, the engaging parts are assembled to the work pieces with hands. But, using the hands is hard to guide the engaging parts to assemble with the work pieces and it results in deficiencies such as the work piece being deformed, scratched or incompletely assembled. In addition, the hands are easy to be hurt during assembling job being performed.

### SUMMARY OF THE INVENTION

Accordingly, an object of the present invention is to provide a device for assembling engaging parts to work pieces for avoiding the work pieces being damaged and the hands of the operator being hurt.

In order to achieve the preceding object, a device for assembling an engaging part being joined to a work piece according to the present invention includes a base, a driving part, a locating part, a press part and an expanding part. The base is a rectangular frame provides a rectangular hollow space. The driving part is disposed at one of the frame sides of the base. The locating part is disposed in the hollow space and beside the driving part. The press part is disposed in the hollow space and joined to the locating part such that it is capable of moving reciprocally. The work piece pan is disposed in the hollow space next to another frame side of the base and is opposite to the press part.

The assembling device according to the present invention further includes a holding part for preventing the work piece from moving vertically along the thickness of the base.

The assembling device according to the present invention wherein the work piece pan provides at least a recess for accommodating one of the work pieces and a first groove is provided for receiving the expanding part.

The assembling device according to the present invention wherein the recess further provides a second groove for accommodating projection sections of the work pieces.

The assembling device according to the present invention wherein the locating part further includes:

two guide rods providing a first end and a second end, the first end penetrating the first frame side via the outer edge of the first frame side and inserting into the second frame side via the inner edge of the second frame side such that the two guide rods are disposed beside the work piece pan symmetrically;

a push strap providing two through hole corresponding to the two guide rods respectively and being attached to the outer edge of first frame side;

two springs providing a third end and a fourth end and being disposed to surround the guide rods respectively; and

two fitting heads providing a head part and a threaded stem part respectively, both of the head part and the threaded stem part having a first inner bore and a second inner bore to communicate with each other coaxially, the respective threaded stem part fitting with the through holes and the respective head part being fixed to the outer side of the push strap, diameter of the first inner bore being slightly greater than that of the respective guide rod and less than that of the respective spring diameter, diameter of the second inner bore being slightly greater than that of the respective spring such that the first end of the respective guide rod being received in the first inner bore and the respective spring being received in the second inner bore in a way of the second end of the respective spring being biased against the inner edge of the second frame side.

The assembling device according to the present invention wherein an auxiliary press block is fixed to the middle of the outer side of the push strap and joined to the fixing block.

The assembling device according to the present invention wherein the press part provides at least two press legs at a side facing the work piece pan for pressing the engaging part.

The assembling device according to the present invention wherein the expanding part is a block configuration with a rectangular part integral with a tongue part and the tongue part is disposed corresponding to an opening of the engaging part for expanding the opening and guiding toward the work piece.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a preferred embodiment of a device for assembling engaging parts according to the present invention;

FIG. 2 is an exploded perspective view of the device for assembling engaging parts shown in FIG. 1;

FIG. 3 is a top view of the big elbow clamp 21 provided in the preferred embodiment of the device for assembling engaging parts according to the present invention;

FIG. 4 is a front view of the big elbow clamp 21 provided in the preferred embodiment of the device for assembling engaging parts according to the present invention;

FIG. 5 is a perspective view of the press part 30 provided in the preferred embodiment of the device for assembling engaging parts according to the present invention;

FIG. 6 is a perspective view of the expanding part 40 provided in the preferred embodiment of the device for assembling engaging parts according to the present invention;

FIG. 7 is a top view of the small elbow clamp 51 provided in the preferred embodiment of the device for assembling engaging parts according to the present invention;

FIG. 8 is a front view of the small elbow clamp 51 provided in the preferred embodiment of the device for assembling engaging parts according to the present invention; and

FIG. 9 is a plan view illustrating the preferred embodiment of the device for assembling engaging parts according to the present invention while in use.

### DETAILED DESCRIPTION OF THE INVENTION

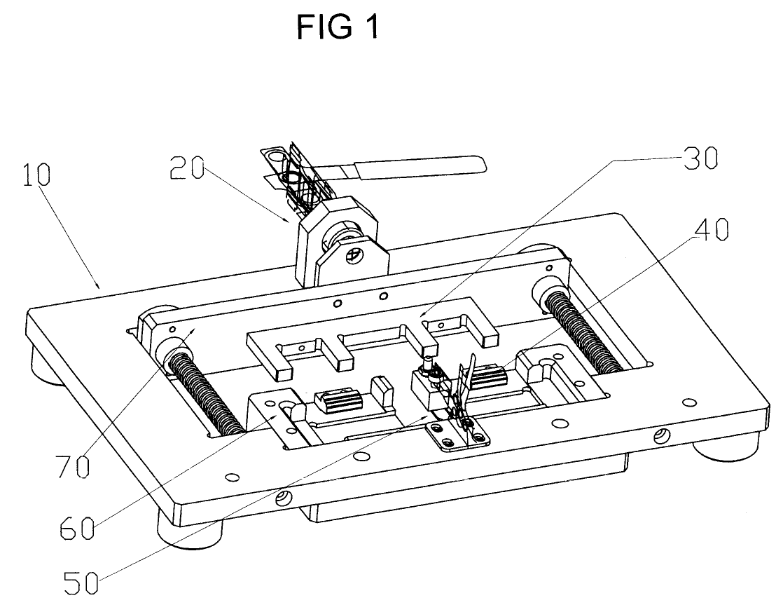

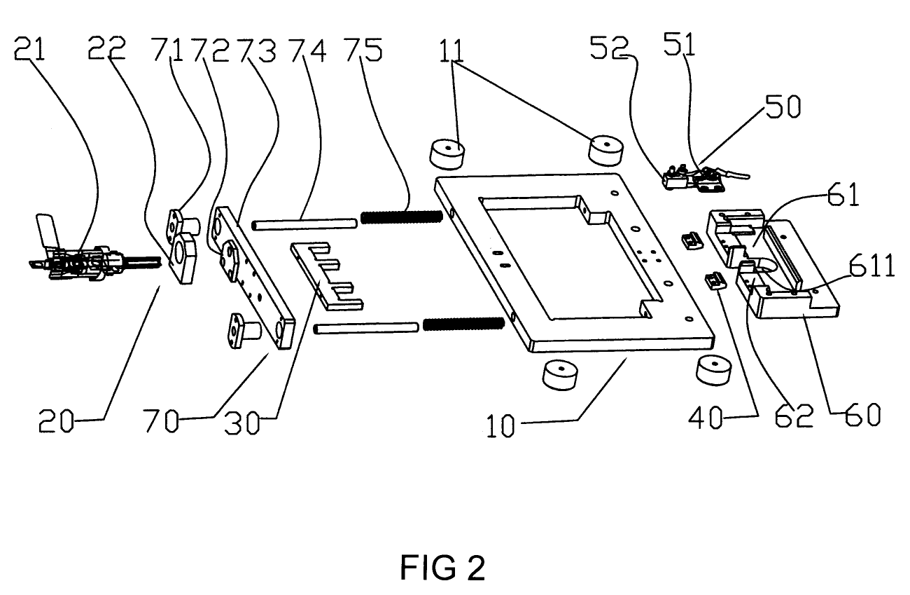

Referring to FIGS. 1 and 2, a device for assembling engaging parts to work pieces according to the present invention includes a base 10, a driving part 20, a press part 30, two expanding parts 40, a holding part 50, a work piece pan 60 and a locating part 70. The base 10 is a rectangular frame with a rectangular hollow space and four foot pads 11 are disposed at four corners of the bottom of the base 10. Further, there are fixing holes near a frame side of the base 10 for the base 10 being held firmly. The driving part 20 and the holding part 50 are fastened to two long frame sides of the base 10 respectively. The work piece 60 is fixedly disposed in the rectangular hollow space of the base 10 near one of the long frame sides and next to the holding part 50. A recess is provided at the base 10 to accommodate the work piece pan 60. The locating part 70 is arranged in the rectangular hollow space of the base 10. The press part 30 is joined to the locating part 70.

The work piece pan 60 basically is a rectangular block with an extrusion plate at three sides and the middle thereof respectively such that a recess 61 is formed for receiving work pieces during assembling job being performed. A circular groove is provided in the recess 61 for accommodating projection portions of the work pieces. A further long side of the work piece pan 60 has a jutting block, which is next to the recess 61 and provides two small recesses 62.

The locating part 70 is held to one of the long frame sides of the base 10 and includes two fitting heads 71, an auxiliary press block 72, a press strap 73, two guide rods 74 and two springs 75. The two guide rods 74 are arranged to insert through two locating holes, which penetrate a long frame side of the base 10 via the outer edge of the long frame side, and insert into another long frame side opposite to the previous long frame side via the inner edge of the second frame side such that the two guide rods are disposed beside the work piece pan 60 symmetrically. Each of the guide rods 74 is sleeved with one of the springs 75 and an end of the respective guide rod 74 fits with one of the fitting heads 71. The respective fitting head 71 provides a head part and a threaded stem part and both of the head part and the threaded stem part have an inner bore to communicate with each other coaxially. The inner bore of the head part has a diameter slightly greater than that of the respective guide rod 74 and the inner bore of the threaded stem part has a diameter slightly greater than the outer diameter of the respective spring 75. The press strap 73 provides a through hole at two short lateral sides thereof corresponding to the two guide rods 74 for the threaded stem part of the respective fitting head 71 being fixedly attached to the through hole of the press strap 73 respectively from the outer side of the press strap 73 for the press strap 73 being capable of fitting with the guide rods 74. An end of the respective spring 75 is received in the inner bore of the threaded stem part of the respective fitting head and another end of the respective spring 75 is biased against the inner edge of the second frame side of the base 10. The auxiliary press block 72 is fixed to the outer side of the press strap 73 such that the head parts of the fitting heads 71 and the auxiliary press block 72 are disposed outside the press strap 73. The locating part 70 is employed to secure the press part 30 to the press strap 73 and allow the press part 30 being capable of moving reciprocally along the guide rods 74.

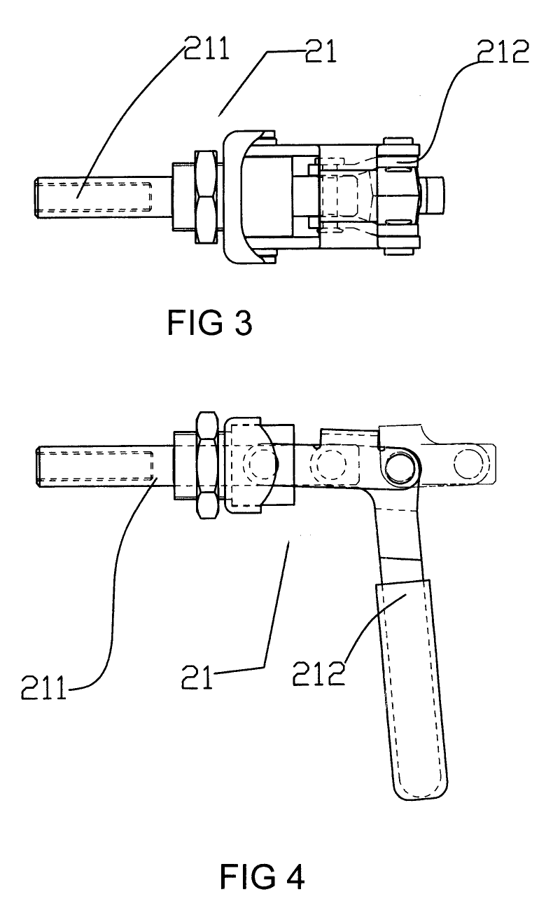

Referring to FIGS. 3 and 4 in company with FIGS. 1 and 2, the driving part 20 includes a big elbow clamp 21 and a fixing block 22. The fixing block 22 with a fixing hole is held to the first frame side of the base 10 and disposed next to the auxiliary press block 72 with the fixing hole being joined to the big elbow clamp 21. The big elbow clamp 21 includes a movable shaft 211 and a stirring handle 212 and the movable shaft 211 is pivotally joined to the stirring handle 212. The big elbow clamp 21 is conventional art and no details will be described further. Of course, other type of driving parts such as rocking handle can be used alternatively.

Referring to FIG. 5 in company with FIG. 1, the press part 30 basically is a rectangular block with four press legs 31 extending from a long side of the rectangular block. The press legs 31 provide a rectangular configuration respectively and are arranged to be disposed equally spacing apart from each other. The press part 30 is attached to the inner side of the press strap 73 of the locating part 70 for pressing fasteners forward to be assembled to the work pieces.

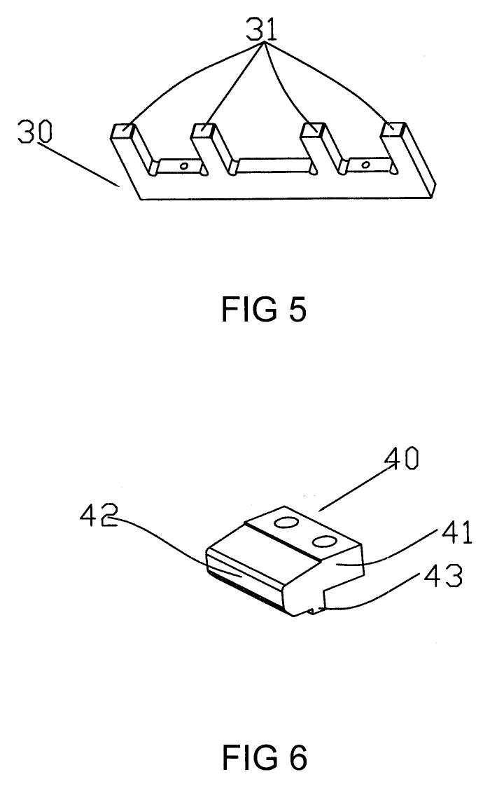

Referring to FIG. 6, the expanding part 40 basically is a rectangular block and includes a main body 41 and a tongue part 42 with a projection 43 at the junction of the main body 41 and the tongue part 42. A step is formed between the main part 41 and the tongue part 42. The expanding part 40 is fixedly disposed in the recess 62 of the work piece pan 60 such that a specific clearance is formed between the tongue part 42 and the bottom of the recess 62 for fitting with the opening of an engaging piece and expanding the opening in advance before assembling with the work pieces.

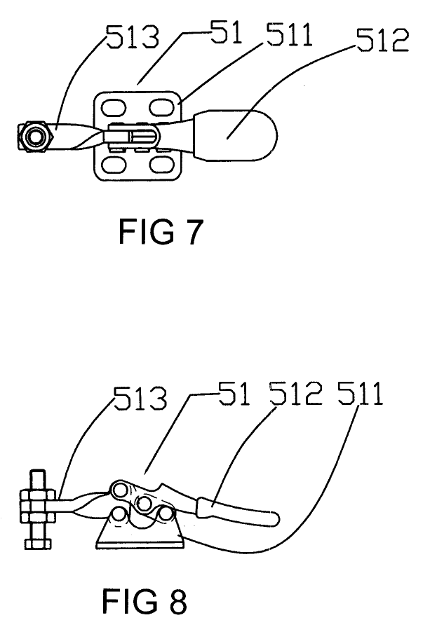

Referring to FIGS. 7 and 8 in company with FIGS. 1 and 2, the holding part 50 includes a small elbow clamp 51 and a press block 52. The small elbow clamp 52 further a bottom plate 511, a press handle 512, a hanging arm 513 and a plurality of pivots. The bottom plate 511 is attached to the second frame side of the base 10 to be opposite to the driving part 20. The press handle 512 and the hanging arm 513 are joined to each other with the pivots and are joined to the bottom plate 511 with the pivots. The press block 52 is attached to an end of the hanging arm 513 for holding the work pieces such that the work pieces are incapable of moving vertically along direction of thickness of the work pieces respectively. The small elbow clamp 51 is conventional art and no detail will be described further. Alternatively, other types of the holding part 50 such as the elastic clamp can be used instead.

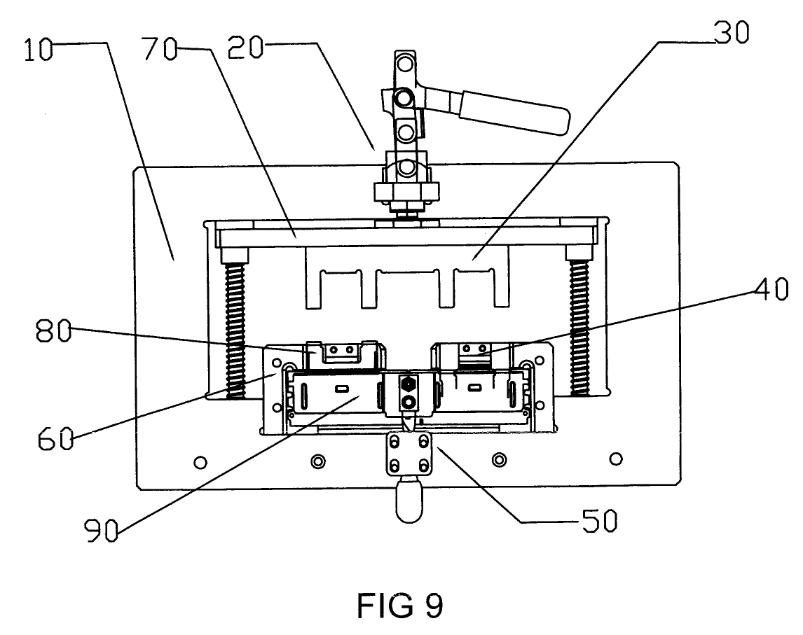

Referring to FIG. 9, an implement of the fixing device according to the present invention for assembling engaging parts to cooling fins 90 is illustrated. In order to explain easily, only an engaging part 80 is shown in the figure. While in operation, the engaging part 80 is expanded with the tongue part 42 of the expanding part 40 first and then one of the cooling fins 90 is placed in the recess 61 of the work piece pan 60. Next, the press handle 512 is pressed down to actuate the hanging arm 513 to rotate such that the press block 52 holds the cooling fin 90 to resist the cooling fin 90 moving vertically along the thickness thereof. Further, the stirring handle 212 is rotated to push the movable shaft 211 forward such that the auxiliary press part 71 is pressed by the movable shaft 211 to move the press part 30 forward and the press legs 31 keep approaching the tail section of the engaging part 80 and push the engaging part 80 to move forward till assembling to the cooling fin 90. In this way, the cooling fin 90 contacts with the engaging part 80 tightly to facilitate heat dissipation. In case of the cooling fin and the engaging part 80 being taken out, the stirring handle 212 is rotated first to allow the movable shaft 211 retreating. Under this circumference, the springs 74 release from pressing force and bring the press part 30 back with the elastic force thereof. The press handle 512 is pressed to lift the hanging arm 513 to allow the press block 52 being away from the assembled work piece. Finally, the assembled cooling fin with the engaging part 80 is picked up completely.

Although, as the forgoing, the device for assembling engaging parts according to the present invention is to assemble the engaging parts to the cooling fins, it is noted that assembling job for other type work pieces with the engaging parts is capable of being implemented and a suitable work piece pan can be replaced for different type work pieces.

While the invention has been described with referencing to a preferred embodiment thereof, it is to be understood that modifications or variations may be easily made without departing from the spirit of this invention, which is defined by the appended claims.

What is claimed is:

1. A device for assembling an engaging part being joined to a work piece, comprising:
a base being a rectangular frame with a first frame side and a second frame side, providing a rectangular hollow space;
a driving part being disposed at the first frame side a locating part being disposed in the hollow space and beside the driving part;
a press part being disposed in the hollow space, being joined to the locating part and being capable of moving reciprocally;
a work piece pan being disposed in the hollow space next to the second frame side and being opposite to the press part; and
at least an expanding part being disposed in the work piece pan.

2. The device as defined in claim further comprises a holding part, which is disposed at the second frame side next to the work piece pan.

3. The device as defined in claim 1, wherein work piece pan provides at least a recess for accommodating one of the work pieces and a first groove is provided for receiving the expanding part.

4. The device as defined in claim 3, wherein the recess further provides a second groove for accommodating projection sections of the work pieces.

5. The device as defined in claim 1, wherein locating part further comprises:
two guide rods providing a first end and a second end, the first end penetrating the first frame side via the outer edge of the first frame side and inserting into the second frame side via the inner edge of the second frame side such that the two guide rods are disposed beside the work piece pan symmetrically;
a push strap providing two through hole corresponding to the two guide rods respectively and being attached to the outer edge of first frame side;
two springs providing a third end and a fourth end and being disposed to surround the guide rods respectively; and
two fitting heads providing a head part and a threaded stem part respectively, both of the head part and the threaded stem part having a first inner bore and a second inner bore to communicate with each other coaxially, the respective threaded stem part fitting with the through holes and the respective head part being fixed to the outer side of the push strap, diameter of the first inner bore being slightly greater than that of the respective guide rod and less than that of the respective spring diameter, diameter of the second inner bore being slightly greater than that of the respective spring such that the first end of the respective guide rod being received in the first inner bore and the respective spring being received in the second inner bore in a way of the second end of the respective spring being biased against the inner edge of the second frame side.

6. The device as defined in claim 1, wherein an auxiliary press block is fixed to the middle of the outer side of the push strap and joined to the fixing block.

7. The device as defined in claim 1, wherein the press part provides at least two press legs at a side facing the work piece pan for pressing the engaging part.

8. The device as defined in claim 1, wherein the expanding part is a block configuration with a rectangular part integral with a tongue part and the tongue part is disposed corresponding to an opening of the engaging part for expanding the opening and guiding toward the work piece.
